(19) United States
(12) Patent Application Publication
(10) Pub. No.: US 2014/0308420 A1
(43) Pub. Date: Oct. 16, 2014

(54) SYSTEMS, APPARATUSES, AND METHODS FOR FORMING AND TEXTURING COMESTIBLE PRODUCT

(71) Applicant: Formax, Inc., Mokena, IL (US)

(72) Inventors: Doug A. Conerton, Bourbonnais, IL (US); AI R. Seemann, Peotone, IL (US); Joseph A. Ebert, Lockport, IL (US); Neil S. Hayden, Braidwood, IL (US)

(73) Assignee: Formax, Inc., Mokena, IL (US)

(21) Appl. No.: 14/248,925

(22) Filed: Apr. 9, 2014

Related U.S. Application Data
(60) Provisional application No. 61/810,572, filed on Apr. 10, 2013.

(51) Int. Cl. A22C 7/00; A23L 1/00

(52) U.S. Cl. CPC A22C 7/0076; A23L 1/0073
USPC 426/513; 425/422

(57) ABSTRACT

Systems, apparatuses, and methods for forming and texturing a comestible product are provided. In one aspect a machine includes a product hopper adapted to receive comestible product, and a product forming and texturing assembly. The assembly includes a plate defining a product opening therein, and a texturing unit coupled to the plate and including a plurality of projections extending therefrom into the product opening to form indentations in comestible product positioned in the product opening The machine also includes a knock-out mechanism adapted to engage comestible product positioned in the product opening in order to dislodge the comestible product from the product opening. The assembly is moveable between a first position, in which comestible product is adapted to be introduced into the product opening from the product hopper, and a second position, in which the knock-out mechanism is adapted to engage the comestible product positioned in the product opening.

### RELATED APPLICATIONS

The present application claims the benefit of co-pending U.S. Provisional Patent Application No. 61/810,572, filed Apr. 10, 2013, the contents of which are incorporated by reference herein in their entirety.

### FIELD OF THE DISCLOSURE

The present disclosure generally relates to machines for handling comestible product and, more particularly, to machines for forming and texturing comestible product such as, for example, red meat, pork, poultry, fish, etc.

### BACKGROUND

Comestible products, such as red meat, pork, poultry, and fish, may be ground and formed into a desired shape such as a patty, a “nugget”, or a fish stick. A first machine is used to form the comestible product into the desired shape. Then, a laborer must physically move the formed comestible product to a second machine where a desired texturing may be applied to the formed product. Such texturing may include indentations in a surface of the formed product such that the formed product does not have smooth, flat surfaces. Such texturing may be referred to as perforating the formed product. After texturing the formed product, the textured and formed product is dropped onto paper or other material for packaging. The laborer picks up the paper/material and the textured, formed product and physically moves it to a packaging container.

### SUMMARY

The present disclosure is defined by the following claims, and nothing in this section should be taken as a limitation on those claims.

In one aspect, the disclosure relates to forming and texturing comestible product such as, for example, red meat, pork, poultry, and fish.

In another aspect, the disclosure relates to a single machine that forms and textures comestible product.

In a further aspect, the disclosure relates to a single machine that forms, textures, and drops a comestible product into a packaging container.

In still another aspect, a machine adapted to form and texture comestible product is provided. The machine includes a product hopper adapted to receive comestible product therein, a product forming and texturing assembly including a plate defining a product opening therein, and a texturing unit coupled to the plate and including a plurality of projections extending therefrom into the product opening to form indentations in comestible product positioned in the product opening. The machine also includes a knock-out mechanism adapted to engage comestible product positioned in the product opening in order to dislodge the comestible product from the product opening. The product forming and texturing assembly is moveable between a first position, in which comestible product is adapted to be introduced into the product opening from the product hopper, and a second position, in which the knock-out mechanism is adapted to engage the comestible product positioned in the product opening.

In still a further aspect, a machine adapted to form and texture comestible product is provided and includes a product hopper adapted to receive comestible product, a plate defining a product opening configured to receive comestible product, a texturing unit coupled to the plate and including a plurality of projections extending into the product opening to form indentations in comestible product positioned in the product opening, and a knock-out mechanism adapted to engage comestible product positioned in the product opening in order to dislodge the comestible product from the product opening. The plate is moveable between a first position, in which comestible product is adapted to be introduced into the product opening, and a second position, in which the knock-out mechanism is adapted to engage the comestible product positioned in the product opening.

In yet another aspect, the plate defines a plurality of product openings, and the texturing unit is one of a plurality of texturing units with one texturing unit associated with each product opening.

In yet a further aspect, the knock-out mechanism includes a plurality of knock-out members with one knock-out member associated with each product opening.

In another aspect, the product opening is generally circular.

In a further aspect, the texturing unit includes a plurality of spaced-apart, parallel members defining spaces between the spaced-apart, parallel members.

In still another aspect, at least one of the plurality of projections extends from one of the spaced-apart, parallel members and at least another one of the plurality of projections extends from another one of the spaced-apart, parallel members.

In still a further aspect, the knock-out mechanism includes a plurality of spaced-part, parallel members adapted to insert into the spaces defined by the texturing unit to engage and dislodge comestible product positioned in the product opening.

In yet another aspect, the machine further includes a stationary forming plate defining a plurality of recesses therein. The plurality of spaced-apart, parallel members of the texturing unit are disposed in the plurality of recesses with the plate in the first position.

In yet a further aspect, the plurality of spaced-apart, parallel members of the texturing unit are removed from the plurality of recesses defined in the stationary forming plate with the plate in the second position.

In another aspect, the plurality of projections together define a texture area that is complementary in shape to the product opening.

In a further aspect, the texture area has a generally circular perimeter and the product opening is generally circular in shape.

In still another aspect, the texturing unit is rigidly coupled to the plate and is moveable with the plate between the first position and the second position.

In still a further aspect, a machine adapted to form and texture comestible product is provided and includes a product hopper adapted to receive comestible product and a plate defining a plurality of product openings therein. Each of the plurality of product openings is configured to receive comestible product, and the plate is movable between a first position, in which comestible product is adapted to be introduced into the plurality of product openings, and a second position, displaced from the first position where the comestible product is dislodged from the plurality of product openings. The machine also including a plurality of texturing units rigidly coupled to and moveable with the plate. Each of the plurality of texturing units is associated with one of the plurality of product openings and includes a plurality of projections extending into the associated product opening to form indentations in comestible product positioned in the associated product opening. The plurality of projections on each of the plurality of texturing units together define a texture area that is complementary in shape to the associated product opening. The machine further includes a plurality of knock-out members. Each one of the plurality of knock-out members is associated with one of the plurality of product openings and is adapted to engage comestible product positioned in the associated product opening in order to dislodge the comestible product from the associated product opening when the plate is in the second position.

In yet another aspect, the plurality of product openings are generally circular, and the plurality of texture areas have a generally circular perimeter.

In yet a further aspect, each of the plurality of texturing units includes a plurality of spaced-apart, parallel members defining spaces between the spaced-apart, parallel members. Each of the plurality of knock-out members includes a plurality of spaced-part, parallel members adapted to insert into the spaces defined by the associated texturing unit to engage and dislodge comestible product positioned in the product opening.

In another aspect, a method of forming and texturing a comestible product is provided and includes positioning a mold plate in a first position, introducing comestible product into a product opening defined in the mold plate when the mold plate is in the first position, texturing the comestible product with projections positioned in the product opening while the mold plate is in the first position, moving the mold plate to a second position displaced from the first position, and dislodging the comestible product from the product opening with a knock-out member when the mold plate is in the second position.

In a further aspect, texturing further comprises indenting a surface of the comestible product with the projections.

In still another aspect, the method further comprises interlacing a texturing unit and a forming plate to provide a substantially continuous top surface to the product opening with the mold plate in the first position. The projections extend from the texturing unit into the product opening.

In still a further aspect, the method further comprises displacing the texturing unit from the forming plate with the mold plate in the second position to provide gaps in the top surface of the product opening, and dislodging further comprises inserting the knock-out member through the gaps to engage and dislodge the comestible product.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a top front perspective view of one example of a comestible product forming and texturing machine.

FIG. 2 is a side view of the machine illustrated in FIG. 1.

FIG. 3 is a front view of the machine illustrated in FIG. 1.

FIG. 4 is a top front perspective view of one example of a product forming and texturing assembly including one example of a plate and one example of a plurality of texture units, the plate defines one example of a plurality of product openings having a generally circular shape.

FIG. 5 is a top view of the product forming and texturing assembly illustrated in FIG. 4.

FIG. 6 is a front view of the product forming and texturing assembly illustrated in FIG. 4.

FIG. 7 is a side view of the product forming and texturing assembly illustrated in FIG. 4.

FIG. 8 is a bottom view of a portion of the product forming and texturing assembly illustrated in FIG. 4.

FIG. 9 is a bottom perspective view of a portion of the product forming and texturing assembly illustrated in FIG. 4.

FIG. 10 is an exploded view of the product forming and texturing assembly illustrated in FIG. 4.

FIG. 11 is a bottom perspective view of a portion of the product forming and texturing assembly illustrated in FIG. 4 along with one example of a forming plate.

FIG. 12 is a top perspective view of a portion of one example of a product knock-out mechanism, the mechanism including four exemplary knock-out members.

FIG. 13 is a top view of one of the knock-out members illustrated in FIG. 12.

FIG. 14 is a front view of the knock-out member illustrated in FIG. 13.

FIG. 15 is a side view of the knock-out member illustrated in FIG. 13.

FIG. 16 is a top perspective view of one example of a knock-out member oriented in a knock-out position relative to the product forming and texturing assembly.

FIG. 17 is a top view of another example of a plate including a plurality of examples of product openings having a variety of different shapes.

FIG. 18 is a top view of a further example of a plate including a plurality of examples of product openings having a variety of different shapes.

FIG. 19 is a top view of another example of a product forming and texturing assembly including another example of a plate and two texture units, the plate defines examples of two product openings having a generally circular shape.

FIG. 20 is a top perspective view a further example of a product forming and texturing assembly including another example of a plate and a plurality of independent texture rails or members individually coupled to the plate, the plate defines an example of a product opening having a generally circular shape.

### DETAILED DESCRIPTION

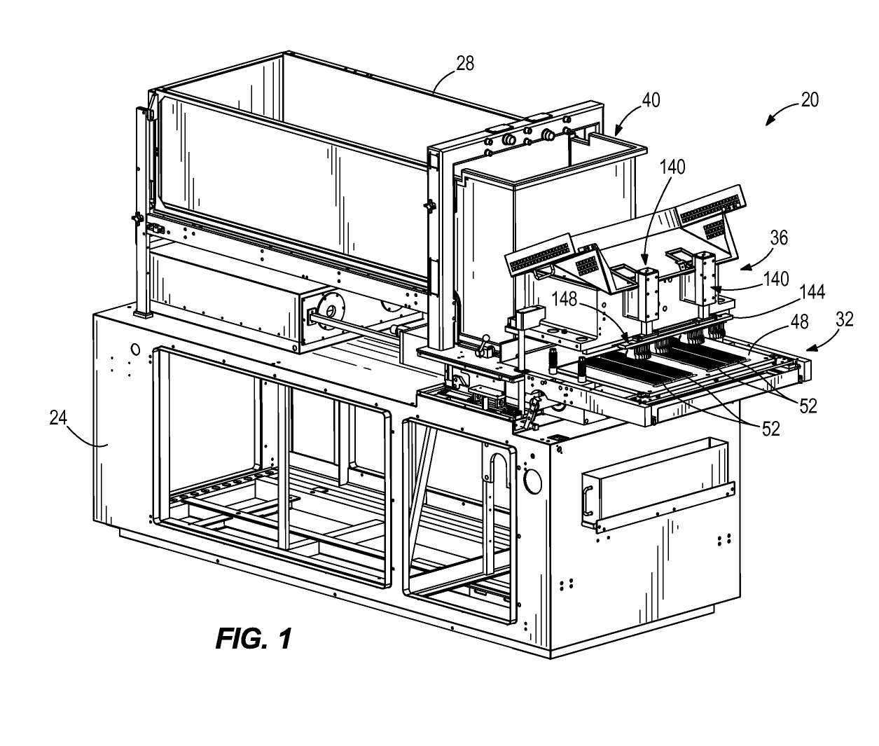

With reference to FIGS. 1-3, one example of a comestible product forming and texturing machine 20 is illustrated. The single machine 20 is adapted to both form comestible product into a desired shape and provide desired texture to the comestible product. The machine 20 is capable of forming and texturing a wide variety of different comestible products such as, for example, red meat, pork, poultry, fish, etc. The machine 20 is also capable of performing a wide variety of texturing to the comestible product. One example of texturing includes perforating.

The machine 20 includes a base 24, a product hopper 28, a product forming and texturing assembly 32, and a product knock-out mechanism 36. The base 24 is adapted to contain a variety of equipment used to power and operate the machine 20 such as, for example, motors, gears, etc. The product hopper 28 is supported on top of the base 24 and is adapted to contain comestible product that will be formed and textured by the machine 20. An auger is positioned in the hopper 28 to drive or force comestible product toward a forward end 40 of the hopper 28, where the product is forced into the product forming and texturing assembly 32. The product may be forced into the assembly 32 in a variety of manners. In the illustrated exemplary embodiment, the product is first forced downward below the assembly 32 and then forced upward into the assembly 32 from below. In other exemplary embodiments, the comestible product may be forced into the assembly 32 from above.

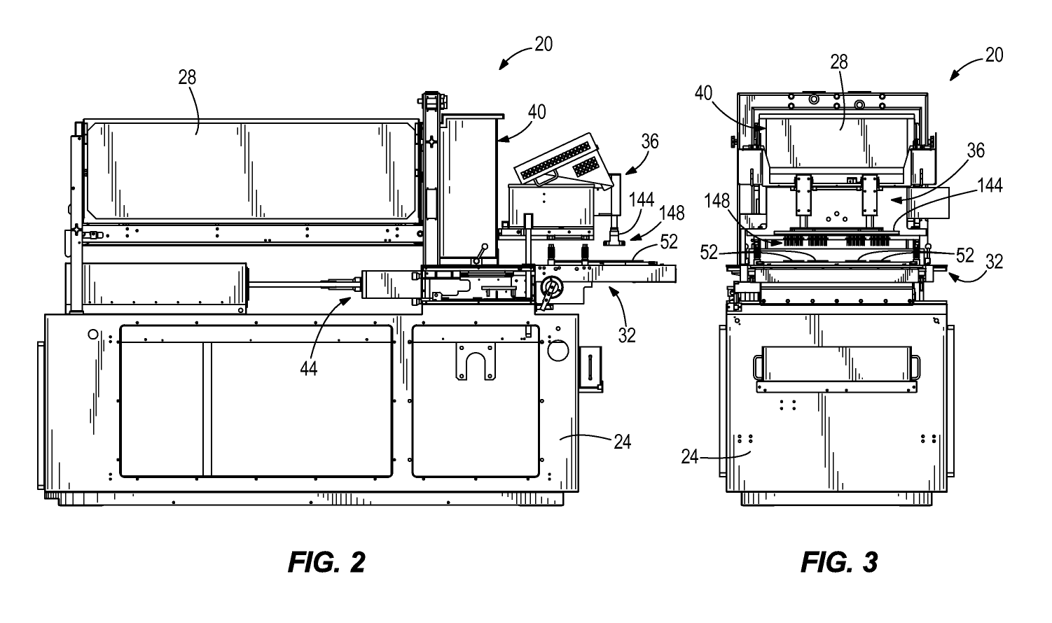

The product forming and texturing assembly 32 is reciprocated forward and rearward by a drive mechanism 44 between a first position, in which the assembly 32 is positioned rearward within the machine 20 near the forward end 40 of the product hopper 28 where product is forced into the assembly 32 to be formed and textured, and a second position, in which the assembly 32 is positioned forward (see FIGS. 1 and 2) extended from a front of the machine 20 and aligned with the product knock-out mechanism 36 where the product may be knocked-out of or dislodged from the assembly 32 from above. The knock-out mechanism 36 is adapted to reciprocate between a retracted position, in which the knock-out mechanism 36 is positioned upward away from the assembly 32 (see FIGS. 1-3), and an extended or knock-out position, in which the knock-out mechanism 36 is extended toward the assembly 32 to knock-out the product from the assembly 32 (see FIG. 16). The product is adapted to fall from the assembly 32 and a conveyor system or a portion of a packaging device may be positioned underneath the assembly 32 when the assembly 32 is in the second position such that the product will fall from the assembly 32 and into a packaging container. A packaging container filled with product may then be conveyed out from underneath the assembly 32 and downstream along the conveyor for completion of the packaging process. An unfilled packaging container is conveyed underneath the assembly 32 to receive the next cycle of product knocked-out from the assembly 32.

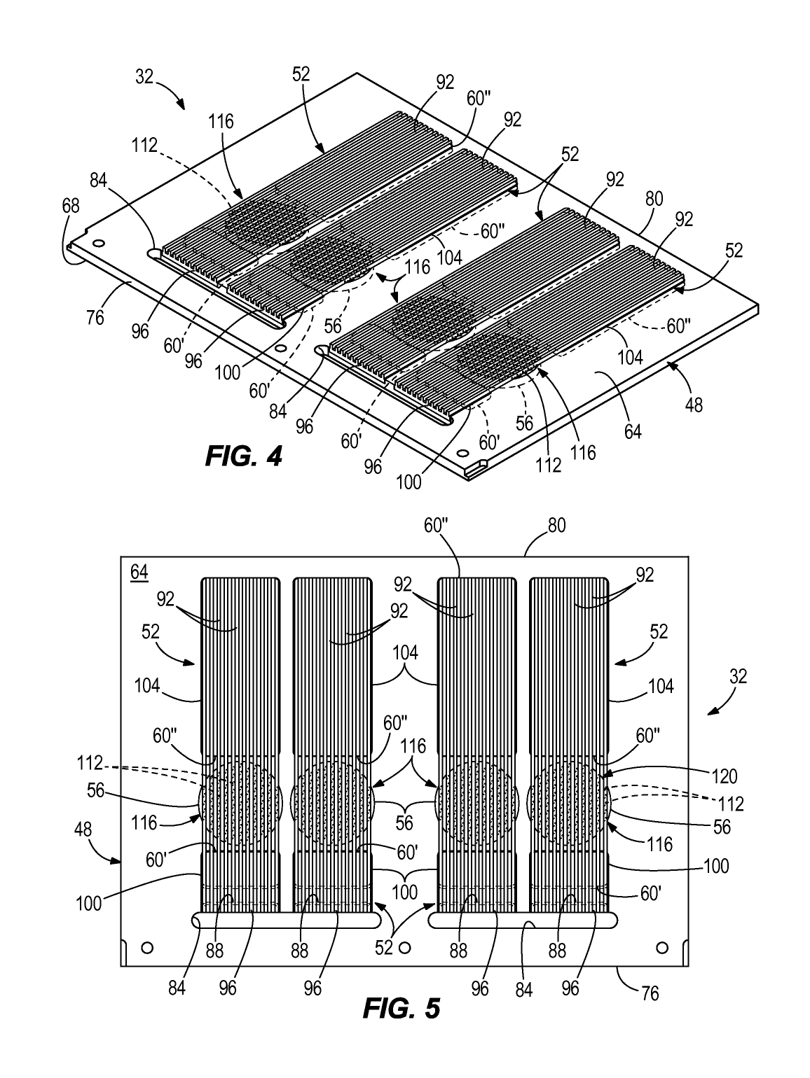

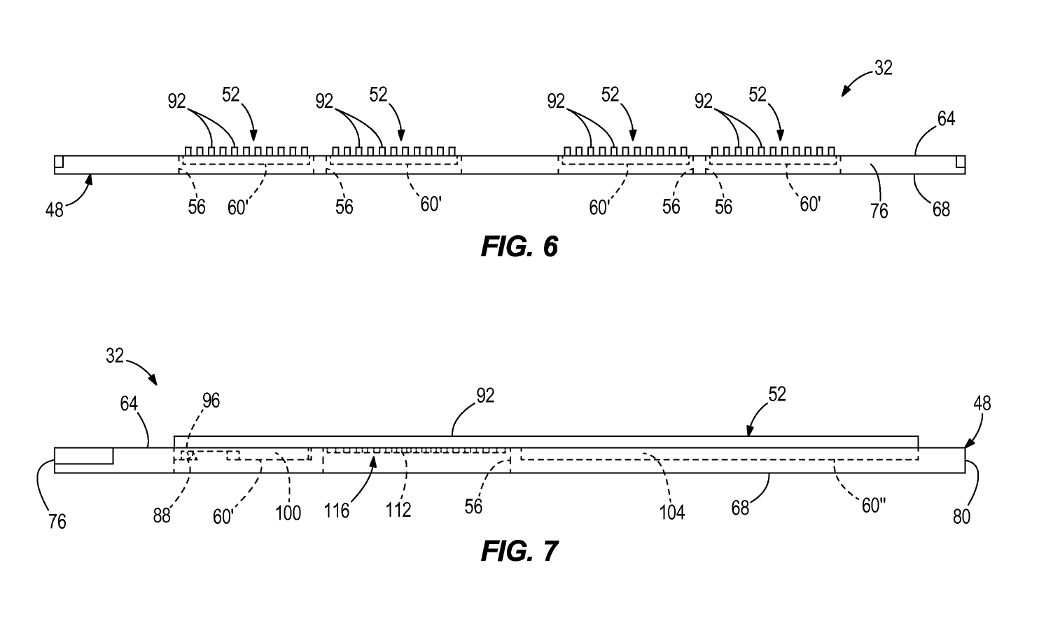

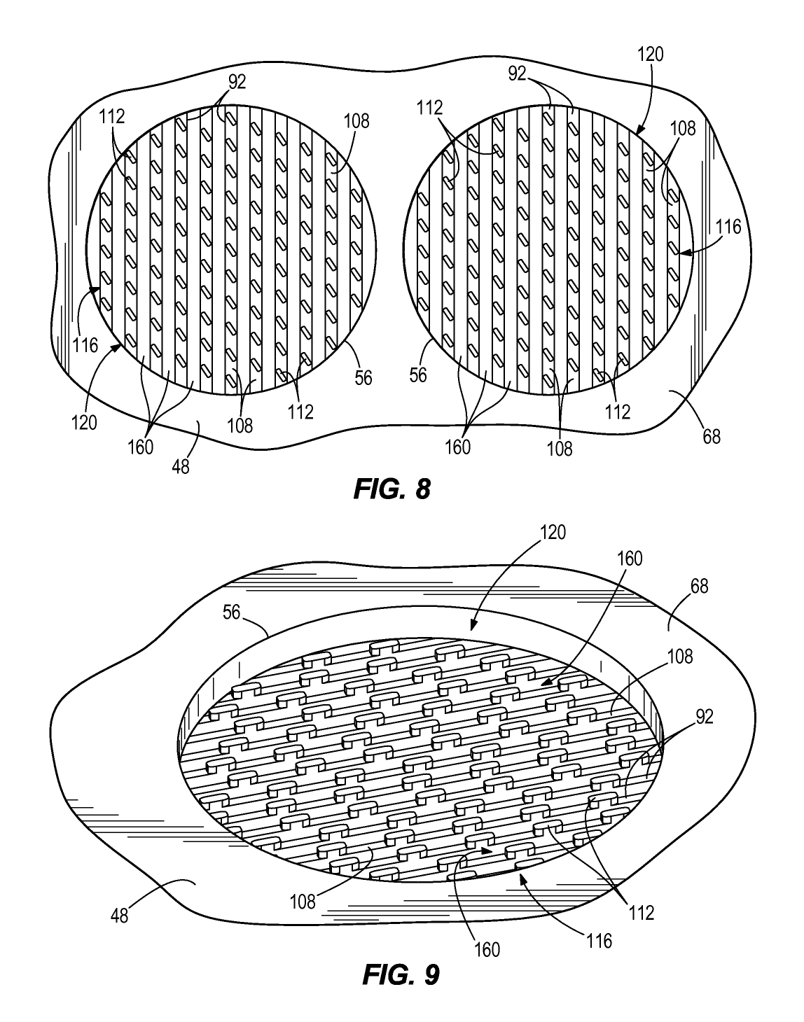

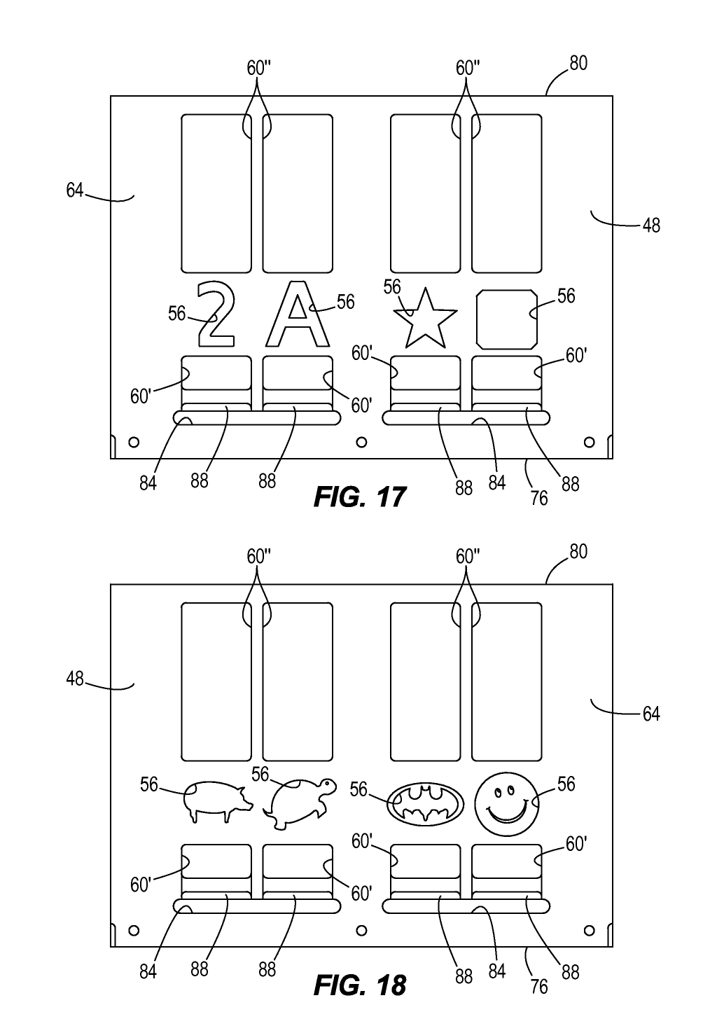

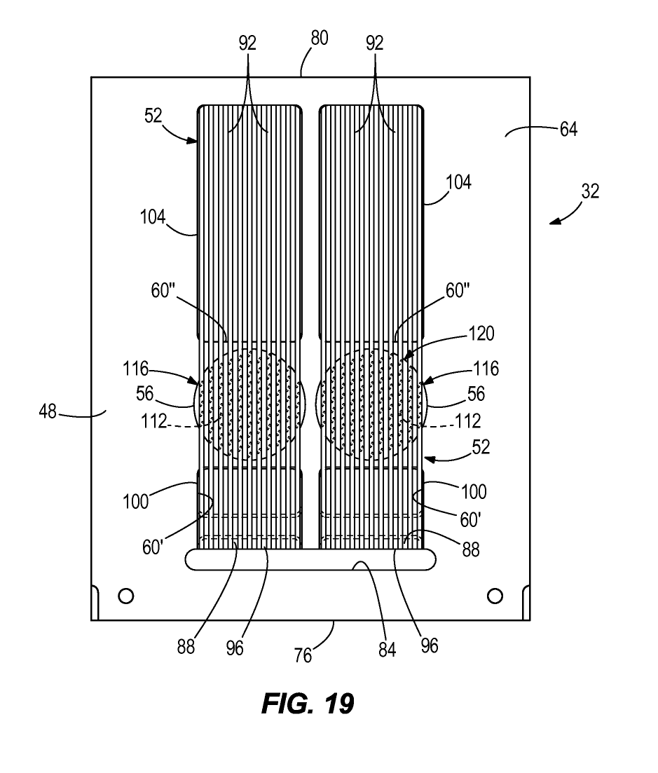

Referring now to FIGS. 4-10, one example of a product forming and texturing assembly 32 is illustrated. The exemplary assembly 32 includes a plate 48 and a plurality of product texturing units 52. In the illustrated example, the plate 48 defines four product openings 56 generally having a circular shape and four sets of unit apertures 60 adapted to couple four product texturing units 52 to the plate 48. While the exemplary illustrated assembly 32 includes four product openings 56, four units 52, and four sets of unit apertures 60, it should be understood that the assembly 32 is adapted to include any number of product openings 56, any number of units 52, and any number of unit apertures 60, and all of such possibilities are intended to be within the spirit and scope of the present disclosure. For example, with reference to FIG. 19, the assembly 32 may include two openings 56, two product openings 56, two units 52, and two sets of unit apertures 60. It should also be understood that the machine 20 is adapted to form comestible product into a variety of different shapes and, as a result, the product openings 56 are adapted to have a variety of different shapes to form such various product shapes. For example, with reference to FIGS. 17 and 18, the plates 48 define a wide variety of exemplary product openings 56 having a wide variety of shapes such as numbers, letters, polygonal perimetered shapes, arcuately perimetered shapes, shapes having combinations of polygonal and arcuate perimeters, animals, emblems, logos, etc. Thus, comestible product is adapted to be formed into these and a wide variety of other shapes by the machine 20. It should further be understood that the product openings 56 may have a wide variety of sizes.

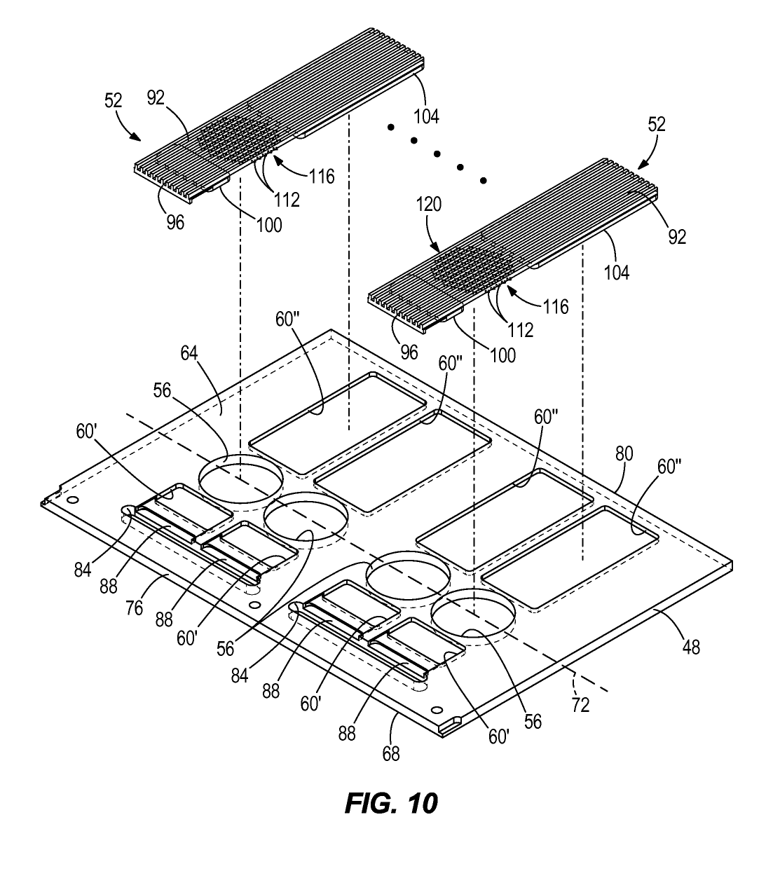

Returning to FIGS. 4-10, the product openings 56 are defined through the plate 48 from a first or top surface 64 to a second or bottom surface 68 opposite the first surface 64. The product openings 56 are generally aligned with each other relative to a front edge 76 and a rear edge 80 (e.g., the products openings 56 are equidistant to the front edge 76 and/or the rear edge 80), and a common central axis 72 (see FIG. 10) generally extends through a center of each of the product openings 56 with the axis 72 extending generally parallel to the front edge 76 and the rear edge 80 of the plate 48. The four sets of unit apertures 60 are similar and each set includes a first or front aperture 60′ positioned to a first or front side of the product opening 56 and a second or rear aperture 60″ positioned to a second or rear side of the product opening 56. Two elongated slots or apertures 84 are defined in the plate 48 near the first edge 76 of the plate 48 with one slot 84 in communication with two of the first apertures 60′. A recess 88 is defined between the slots 84 and each of the first apertures 60′.

The product texturing units 52 are similarly structured with each unit 52 being a unitarily formed one-piece unit 52. The units 52 may be made of a wide variety of materials safe for use in comestible product handling such as, for example, copper alloy, stainless steel, plastic, etc. Each unit 52 includes a plurality of parallel spaced-apart members 92, a first coupling member 96 coupled to the members 92 at a first or front end of the unit 52, a second coupling member 100 coupled to the members 92, and a third or rear coupling member 104 coupled to the members 92 at a second or rear end of the unit 52. The second coupling member 100 is coupled to the members 92 between the first and third coupling members 96, 104. The coupling members 96, 100, 104 are coupled to and extend from a bottom 108 of the members 92 and are adapted to couple the unit 52 to the plate 48. The first coupling member 96 is aligned with and adapted to be positioned in the recess 88, the second coupling member 100 is aligned with and adapted to be positioned in the first aperture 60′, and the third coupling member 104 is aligned with and adapted to be positioned in the second aperture 60″. The units 52 are coupled to the plate 48 from above and are supported on top of the plate 48. The coupling members 96, 100, 104 and associated recess 88 or aperture 60′, 60″ may interact with each other by an interference-fit or friction-fit, or the coupling members 96, 100, 104 may loosely be positioned in the associated recess 88 or apertures 60′, 60″ and maintained in place by gravity. The coupling members 96, 100, 104 and the associated recess 88 or apertures 60′, 60″ are complementarily shaped to inhibit significant movement of the unit 52 relative to the plate 48 when the unit 52 is coupled to the plate 48. In some instances, the coupling members 96, 100, 104 and associated recess 88 and apertures 60′, 60″ may be configured to prevent movement of the unit 52 relative to the plate 48. The elongated slots 84 defined in the plate 48 may provide a person with a location to grasp the texture units 52 and remove the texture units 52 from the plate 48. That is, a person may insert his/her fingers into the slot 84 and grasp a front of the texture units 52.

Each texturing unit 52 includes a plurality of texturing projections 112 extending from a bottom surface 108 of the spaced-apart members 92 with each projection 112 adapted to provide an indentation in the comestible product. The projections 112 together define a texture zone or area 116 including a perimeter or boundary 120 on the unit 52. The perimeter 120 of the texture area 116 is shaped generally complementary to the shape of the product opening 56 defined in the plate 48. In the illustrated exemplary embodiment, the product opening 56 is generally circular shaped and the perimeter 120 of the texture area 116 is also generally circular shaped. As indicated above, the product opening 56 may be a wide variety of shapes and, likewise, the perimeter 120 of the texture area 116 defined on the texturing unit 52 may be a wide variety of complementary shapes.

Within the perimeter 120 of the texture area 116, the projections 112 may have a wide variety of configurations. For example, any number of projections 112 may extend from a single member 92 (including zero) and the projections 112 may be spaced-apart from each other at any distance, offset relative to other projections 112 on adjacent members 92 in any manner, aligned relative to other projections 112 on adjacent members 92 in any manner, etc. In the illustrated exemplary embodiment, the texturing projections 112 are generally square or rectangular shaped. In other exemplary embodiments, the projections 112 may have any other configuration such as, for example, triangular, round, semi-circular, hemi-spherical, conical, frusto-conical, any other polygonal perimetered shape, any other arcuately perimetered shape, or a combination of polygonal and arcuately perimetered shape. It should be understood that, no matter the shape of the projections 112, the projections 112 may be any size (relatively small to relatively large) in order to provide a desired depth, width, and length of an indentation in the comestible product. In the illustrated exemplary embodiment, all of the texture areas 116 of all the units 52 include the same shaped projections 112. In other exemplary embodiments, differently shaped projections 112 may be included in different texture areas 116 on different units 52. In further exemplary embodiments, a texture area 116 on one unit 52 may include projections 112 with different shapes, sizes, configurations, etc.

The texture units 52 provide a wide range of texturing possibilities due to the flexibility provided by the various features of the texture units 52. That is, such flexibility is provided by the various perimeter configurations of the texture area 116 and the various shapes, sizes, and spacing of the projections 112 within the texture area 116 and/or between texture areas 116 in multiple texture units 52.

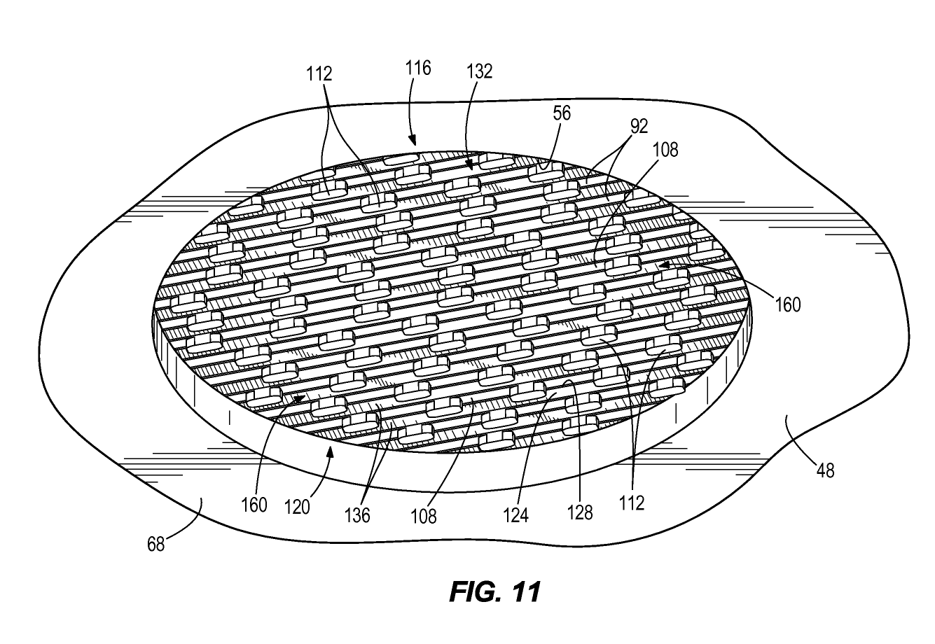

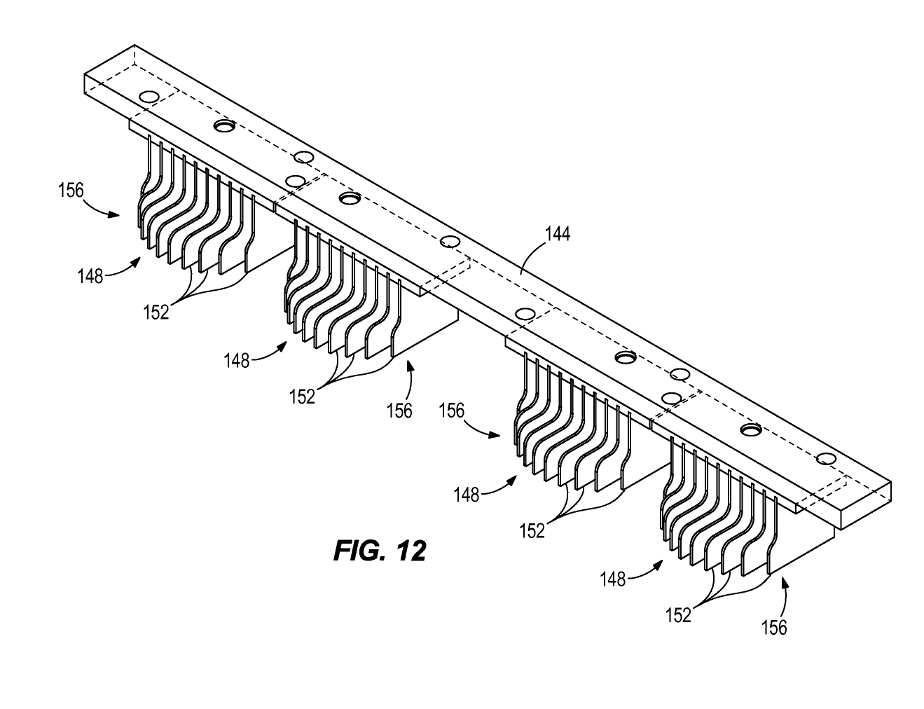

Referring now to FIG. 11, the forming and texturing assembly 32 is adapted to interact with a forming plate 124 to assist with forming the comestible product. The forming plate 124 is a stationary plate positioned above the reciprocating assembly 32 and in a location that cooperates with the assembly 32 when it is in the first position where product is moved into the product opening 56 of the plate 48. The forming plate 124 defines a plurality of elongated recesses 128 therein that are complementarily shaped and oriented to receive the spaced-apart members 92 of the texturing units 52. As the assembly 32 moves or reciprocates between positions, the spaced-apart members 92 of the texturing units 52 slide or move within the recesses 128. The recesses 128 are sized and shaped to cooperate with the spaced-apart members 92 to provide a substantially flush or flat top surface 132 to the product opening 56 when the assembly 32 is in the first or product filing position with only the texturing projections 112 extending into the product opening 56 below the flush top surface 132. The flush top surface 132 of the product opening 56 is defined by plate surfaces 136 between the recesses 128 and bottom surfaces 108 of the spaced-apart members 92 between texturing projections 112. This flush top surface 132 provides a flat top surface against which to force product as it moves into the product opening 56, thereby resulting in a formed comestible product with a flat top surface. The texturing projections 112 apply the desired texturing or indentations to the top surface of the formed product so the top surface of the formed product is not completely flat and smooth. The forming plate 124 is appropriately sized to interlace with the spaced-apart members 92 adjacent the product opening 56 when the assembly 32 is in the first or fill position, but does not interlace with the spaced-apart members 92 adjacent the product opening 56 when the assembly 32 is in the second or knock-out position.

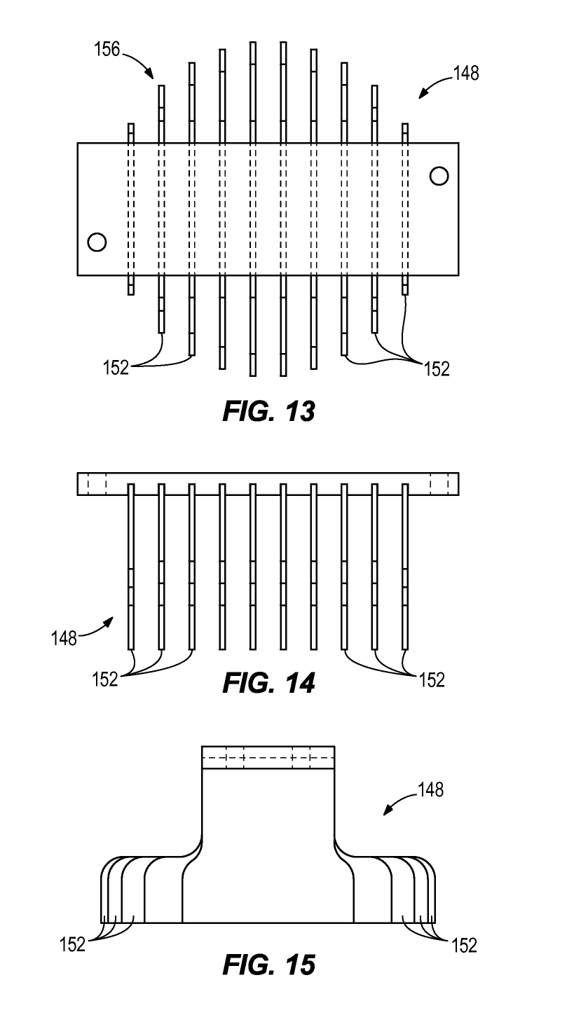

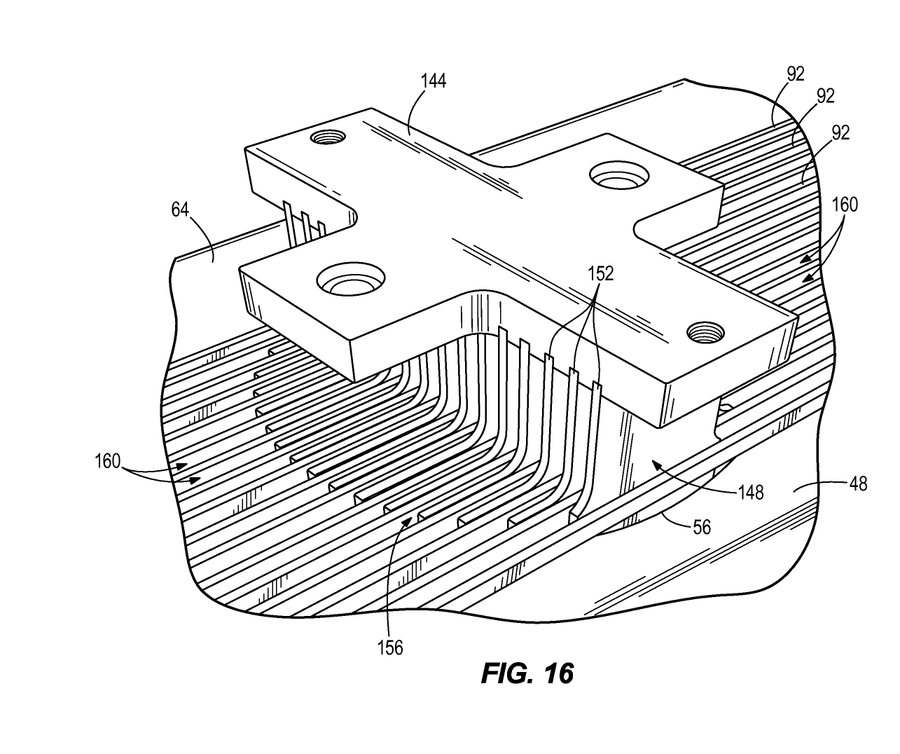

With reference to FIGS. 1-3 and 12-16, the knock-out mechanism 36 is illustrated and is adapted to knock-out the formed comestible product from the product opening 56 of the assembly 32 when the assembly 32 is in the second or knock-out position. The knock-out mechanism 36 is adapted to reciprocate between the retracted position and the extended or knock-out position. In the illustrated exemplary embodiment, the knock-out mechanism 36 includes a pair of actuators 140, a base 144 coupled to the actuators 140, and four knock-out members 148 coupled to the base 144. The knock-out members 148 have a shape that is complementary to the shape of the product openings 56 and are appropriately sized, shaped, and positioned to cooperate with the product openings 56 defined in the assembly 32. As indicated above, the assembly 32 is adapted to include a wide variety of shapes, sizes, configurations, and quantity of product openings 56. Thus, the knock-out mechanism 36 is adapted to include knock-out members 148 of a wide variety of shapes, sizes, configurations and quantity to complement all the possibilities of the product openings 56.

In the illustrated exemplary embodiment, each knock-out member 148 includes a plurality of spaced-apart, parallel members 152 having varying lengths to provide a circular perimeter 156 to the knock-out member 148. This perimeter 156 may be a wide variety of shapes and sizes to complement the shape and size of the associated product opening 56. The spaced-apart members 152 are appropriately spaced to be offset from the spaced-apart members 92 in the texturing unit 52 such that the spaced-apart members 152 of the knock-out mechanism 36 will insert into spaces 160 between the spaced-apart members 92 of the texturing unit 52 without interference with the texturing unit 52, and engage and knock-out the formed and textured comestible product from the assembly 32 (see FIG. 16). In the illustrated exemplary embodiment, the knock-out member 148 includes one member 152 for each space 160 between members 92 in the texturing unit 52 in order to occupy every space 160 between members 92 in the texturing unit 52 and maximize engagement between the knock-out mechanism 36 and the formed and textured comestible product. In other exemplary embodiments, the knock-out member 148 may include fewer spaced-apart members 152 to occupy fewer spaces 160 and decrease engagement between the knock-out member 148 and the formed and textured comestible product.

Operation of the comestible product forming and texturing machine 20 will be described. Comestible product such as, for example, ground meat, may be introduced into the product hopper 28, the machine 20 may be activated to drive the auger positioned in the product hopper 28, which forces comestible product downstream in the machine 20. The product forming and texturing assembly 32 is moved or retracted into its first position or product fill position where product is forced into the product openings 56 of the assembly 32 from below. The interlaced forming plate 124 and texturing units 52 provide a top surface or limiting surface 132 to the comestible product being introduced into the product openings 56. The comestible product assumes the form or shape of the product opening 56 and has a generally flat top surface including texturing comprised of a plurality of indentations provided by the texturing projections 112. As the assembly 32 moves forward toward its second or product knock-out position, the bottom of the plate 48 and product opening 56 are scraped by a scraping member of the machine 20 to provide a substantially flat bottom surface to the formed and textured comestible product in the product openings 56. The assembly 32 then moves into its second or knock-out position, in which the product openings 56 and the formed and textured comestible product are positioned directly beneath the knock-out members 148 of the knock-out mechanism 36. The actuators 140 actuate to move the knock-out mechanism 36 from its retracted position to its extended position, in which the spaced-apart members 152 of the knock-out members 148 insert into the spaces 160 between members 92 in the texturing units 52, engage the formed and textured comestible product, and dislodge or knock-out the product from the product openings 56. A conveyor system adapted to transport packaging containers may be positioned underneath the assembly 32 to move packaging containers into a position to receive the falling formed and textured comestible product therein, thereby eliminating physical or manual labor to transport the dislodged comestible product to a location where the product can be packaged. The present forming and texturing machine 20 also eliminates physical or manual labor required to move formed comestible product from a first forming machine to a second machine adapted to texture the comestible product because the present machine 20 performs both forming and texturing.

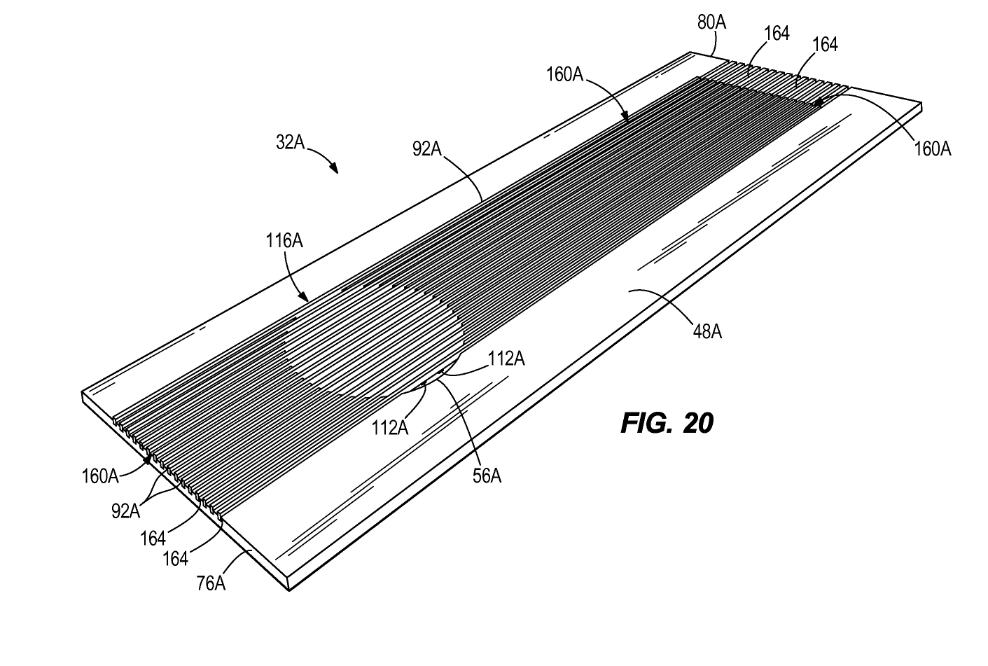

Referring now to FIG. 20, another exemplary product forming and texturing assembly 32A is illustrated. The assembly 32A illustrated in FIG. 20 may have similarities to the assemblies illustrated in FIGS. 1-19 and described herein, and like components have the same reference number and an “A”.

In this exemplary illustrated embodiment, the assembly 32A includes a plate 48A defining a plurality of spaced-apart, parallel recesses 164 therein. The recesses 164 extend from a front edge 76A of the plate 48A to a rear edge 80A of the plate 48A. The assembly 32A also includes a plurality of independent and separate rails or members 92A with one member 92A positioned in each of the recesses 164. The members 92A are coupled to the plate 48A within the recesses 164 and may be individually coupled and removed from the plate 48A as desired. In some exemplary instances, if one of the members 92A are damaged or require removal from the plate 48A, only that particular one of the members 92A needs to be removed and replaced with a new member 92A without having to remove all of the other members 92A.

The members 92A together define a texture area 116A complementary to the product opening 56A and the texture area 116A includes a plurality of texturing projections 112A. The members 92A are also appropriately spaced to interlace with a forming plate and to receive the knock-out member in the spaces 160A between the spaced-apart parallel members 92A to dislodge the formed and textured comestible product from the assembly 32A.

It should be understood that the various exemplary embodiments disclosed herein may include any of the structure, function, and alternatives associated with any of the other exemplary embodiments disclosed herein, and all of such possibilities are intended to be within the spirit and scope of the present disclosure.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While various embodiments of the disclosure have been described, it will be apparent to those of ordinary skill in the art that other embodiments and implementations are possible within the scope of the disclosure. Accordingly, the disclosure is not to be restricted except in light of the attached claims and their equivalents.

1. A machine adapted to form and texture comestible product, the machine comprising:
a product hopper adapted to receive comestible product;
a plate defining a product opening configured to receive comestible product;
a texturing unit coupled to the plate and including a plurality of projections extending into the product opening to form indentations in comestible product positioned in the product opening; and
a knock-out mechanism adapted to engage comestible product positioned in the product opening in order to dislodge the comestible product from the product opening;
wherein the plate is moveable between a first position, in which comestible product is adapted to be introduced into the product opening, and a second position, in which the knock-out mechanism is adapted to engage the comestible product positioned in the product opening.

2. The machine of claim 1, wherein the plate defines a plurality of product openings, and wherein the texturing unit is one of a plurality of texturing units with one texturing unit associated with each product opening.

3. The machine of claim 2, wherein the knock-out mechanism includes a plurality of knock-out members with one knock-out member associated with each product opening.

4. The machine of claim 1, wherein the product opening is generally circular.

5. The machine of claim 1, wherein the texturing unit includes a plurality of spaced-apart, parallel members defining spaces between the spaced-apart, parallel members.

6. The machine of claim 5, wherein at least one of the plurality of projections extends from one of the spaced-apart, parallel members and at least another one of the plurality of projections extends from another one of the spaced-apart, parallel members.

7. The machine of claim 5, wherein the knock-out mechanism includes a plurality of spaced-part, parallel members adapted to insert into the spaces defined by the texturing unit to engage and dislodge comestible product positioned in the product opening.

8. The machine of claim 5, further comprising a stationary forming plate defining a plurality of recesses therein, wherein the plurality of spaced-apart, parallel members of the texturing unit are disposed in the plurality of recesses with the plate in the first position.

9. The machine of claim 8, wherein the plurality of spaced-apart, parallel members of the texturing unit are removed from the plurality of recesses defined in the stationary forming plate with the plate in the second position.

10. The machine of claim 1, wherein the plurality of projections together define a texture area that is complementary in shape to the product opening.

11. The machine of claim 10, wherein the texture area has a generally circular perimeter and the product opening is generally circular in shape.

12. The machine of claim 1, wherein the texturing unit is rigidly coupled to the plate and is moveable with the plate between the first position and the second position.

13. A machine adapted to form and texture comestible product, the machine comprising:
a product hopper adapted to receive comestible product;
a plate defining a plurality of product openings therein, wherein each of the plurality of product openings is configured to receive comestible product, and wherein the plate is movable between a first position, in which comestible product is adapted to be introduced into the plurality of product openings, and a second position, displaced from the first position where the comestible product is dislodged from the plurality of product openings;
a plurality of texturing units rigidly coupled to and moveable with the plate, wherein each of the plurality of texturing units is associated with one of the plurality of product openings and includes a plurality of projections extending into the associated product opening to form indentations in comestible product positioned in the associated product opening, wherein the plurality of projections on each of the plurality of texturing units together define a texture area that is complementary in shape to the associated product opening; and
a plurality of knock-out members, wherein each one of the plurality of knock-out members is associated with one of the plurality of product openings and is adapted to engage comestible product positioned in the associated product opening in order to dislodge the comestible product from the associated product opening when the plate is in the second position.

14. The machine of claim 13, wherein the plurality of product openings are generally circular, and wherein the plurality of texture areas have a generally circular perimeter.

15. The machine of claim 13, wherein each of the plurality of texturing units includes a plurality of spaced-apart, parallel members defining spaces between the spaced-apart, parallel members; and
wherein each of the plurality of knock-out members includes a plurality of spaced-part, parallel members adapted to insert into the spaces defined by the associated texturing unit to engage and dislodge comestible product positioned in the product opening.

16. A method of forming and texturing a comestible product, the method comprising:
positioning a mold plate in a first position;
introducing comestible product into a product opening defined in the mold plate when the mold plate is in the first position;
texturing the comestible product with projections positioned in the product opening while the mold plate is in the first position;
moving the mold plate to a second position displaced from the first position; and
dislodging the comestible product from the product opening with a knock-out member when the mold plate is in the second position.

17. The method of claim 16, wherein texturing further comprises indenting a surface of the comestible product with the projections.

18. The method of claim 16, further comprising interlacing a texturing unit and a forming plate to provide a substantially continuous top surface to the product opening with the mold plate in the first position, wherein the projections extend from the texturing unit into the product opening.

19. The method of claim 18, further comprising displacing the texturing unit from the forming plate with the mold plate in the second position to provide gaps in the top surface of the product opening, and wherein dislodging further comprises inserting the knock-out member through the gaps to engage and dislodge the comestible product.
